(19) United States
(12) Patent Application Publication
(10) Pub. No.: US 2022/0082885 A1
(43) Pub. Date: Mar. 17, 2022

(54) POLARIZING SUBSTRATE AND VARIABLE TRANSMISSIVITY DEVICE INCLUDING THE POLARIZING SUBSTRATE

(71) Applicants: Hyundai Motor Company, Seoul (KR); Kia Motors Corporation, Seoul (KR)

(72) Inventors: Sung Woo Lee, Gwacheon (KR); Han Sol Kang, Yongin (KR)

(21) Appl. No.: 17/095,248

(22) Filed: Nov. 11, 2020

(30) Foreign Application Priority Data
Sep. 16, 2020 (KR) 10-2020-0119040

(51) Int. Cl. G02F 1/1335; G02F 1/1337; G02F 1/1343

(52) U.S. Cl. CPC G02F 1/133528; G02F 2202/022; G02F 1/134309; G02F 1/1337

(57) ABSTRACT

Disclosed are a polarizing substrate and a variable transmissivity device including the polarizing substrate. The variable transmissivity device includes a first polarizing substrate and a second polarizing substrate, each of which includes a transparent base layer and a polarizing layer formed on at least one surface of the base layer, for example, formed by a coating method, a liquid crystal layer disposed between the first polarizing substrate and the second polarizing substrate, a first alignment layer and a first transparent electrode stacked on a first surface of the liquid crystal layer in a direction in which the first polarizing substrate is positioned, and a second alignment layer and a second transparent electrode stacked on a second surface of the liquid crystal layer opposite to the first surface of the liquid crystal layer in a direction in which the second polarizing substrate is positioned.

### CROSS-REFERENCE TO RELATED APPLICATION

This application claims the benefit of priority to Korean Patent Application No. 10-2020-0119040, filed in the Korean Intellectual Property Office on Sep. 16, 2020, the entire contents of which are incorporated herein by reference.

### TECHNICAL FIELD

The present invention relates to a polarizing substrate and a variable transmissivity device including the polarizing substrate.

### BACKGROUND

Recently, instead of a mechanical shading device such as a curtain and/or a blind, a variable transmissivity technology that can adjust the transmissivity through electrical control has been developed. The variable transmissivity technology includes a material having shading function to a film or a glass to change the transmissivity as desired by a user.

The variable transmissivity technology includes an electrochromic (EC) method, a suspended particle display (SPD) method, a polymer dispersed liquid crystal (PDLC) method, or a polarized liquid crystal (LC). The EC method changes the transmissivity through electrolysis and binding of chemical substances. In addition, the SPD, PDLC and LC methods change a phase of a material when an electric field is applied to both ends of the material, thereby changing the transmissivity of light. These variable transmissivity technologies require electric energy, thereby providing a separate power supply.

In the LC method of the variable transmissivity technologies, a polarizer is applied to upper and lower plates based on a liquid crystal layer to transmit or block light depending on a direction of the liquid crystal. As the polarizer, a polarizing film patterned to perform a polarizing function on a triacetyl cellulous (TAC) film may be used. A thickness of the polarizing film is about 15 μm or greater, which accounts for a large proportion of a thickness of the variable transmissivity layer. In addition, it may be necessary to introduce a vacuum processing equipment to attach a pre-fabricated polarizing film (TAC film) to a medium (e.g., plastic film) and a protective film removal process and a lamination process of the polarizing film may be required to increase process cost. In addition, when high heat is applied in the lamination process, damage to the TAC film and/or the plastic film may occur due to a difference in thermal expansion coefficient between the TAC film and the plastic film.

### SUMMARY

In preferred aspects, provided are a polarizing substrate including a polarizing layer and a variable transmissivity device including the polarizing substrate.

The technical problems to be solved by the present inventive concept are not limited to the aforementioned problems, and any other technical problems not mentioned herein will be clearly understood from the following description by those skilled in the art to which the present invention pertains.

In an aspect, provided is a polarizing substrate that may include a transparent base layer and a polarizing layer formed on at least one surface of the base layer. In certain aspects, preferably, the polarizing layer may be formed by a coating method.

The term “transparent base layer”, as used herein, refers to a material formed in a film or a planar structure, which has substantial transmittance of a fraction of light, such as visible light. For instance, substantial amount of visible light such as of about 50%, about 60%, about 70%, about 80%, about 90%, about 95%, about 99%, or greater thereof may transmit or pass through the transparent material constituting the base layer.

The term “polarizing layer”, as used herein, refers to a material formed in a film or planar structure, which can transmit a light or a wave in only one pattern or direction, entirely or partially. The polarizing layer may transmit the wave (e.g., light wave) with or without changing the intensity. Certain exemplary polarizing layer may include a slit or filtering structure that allows transmission of one particular directional pattern of the wave (e.g., light wave) but blocks or absorbs other directional patterns of the wave.

The polarizing layer may have a polarization efficiency which is varied by a silt width formed in the polarizing layer.

The base layer may preferably include a plastic film.

In an aspect, provided is a variable transmissivity device that may include a first polarizing substrate and a second polarizing substrate, each of which may include a transparent base layer and a polarizing layer formed on at least one surface of the base layer, a liquid crystal layer disposed between the first polarizing substrate and the second polarizing substrate, a first alignment layer and a first transparent electrode stacked on a first surface of the liquid crystal layer in a direction in which the first polarizing substrate is positioned, and a second alignment layer and a second transparent electrode stacked on a second surface of the liquid crystal layer opposite to the first surface of the liquid crystal layer in a direction in which the second polarizing substrate is positioned. Preferably, the each of the polarizing layers may be formed by a coating method.

The first transparent electrode may be disposed between a first base layer of the first polarizing substrate and the first alignment layer, and the second transparent electrode may be disposed between a second base layer of the second polarizing substrate and the second alignment layer.

The first transparent electrode may be disposed between a first polarizing layer of the first polarizing substrate and the first alignment layer, and the second transparent electrode may be disposed between a second polarizing layer of the second polarizing substrate and the second alignment layer.

The liquid crystal layer may include a plurality of cells with which a liquid crystal is filled and a spacer to maintain a gap between the plurality of cells.

The liquid crystal may include a polymer.

The “polymer” as used herein refers to a liquid crystal polymer (LCP). The LCP may include or substantially include an aromatic polymer, which may include partially crystalline capable of forming highly ordered structure while maintaining in liquid phase. The LCP may be in a variety of forms, for example, different forms at high temperature or at low temperature, for example, the LCP may be thermoplastics that exhibit properties between highly ordered solid crystalline materials and amorphous disordered liquids. The LCPs have a high mechanical strength at high temperatures, extreme chemical resistance, inherent flame retardancy, and good weatherability.

The spacer may include a ball spacer or a column spacer.

The spacer may include a monomer.

The “monomer” as used herein refers to a resin that may include one or more kinds of monomers. Preferably, the resin may further include a photoinitiator or radical which can initiate polymerization upon light irradiation such as UV light, so the polymer may be hardened, cured or solidified. Exemplary monomer, which may be UV curable, includes, but is not limited to, acrylic compounds (acrylates) such as acrylated epoxies, acrylated polyesters, acrylated urethanes, and acrylated silicones.

Other aspects of the invention are disclosed infra.

### BRIEF DESCRIPTION OF THE DRAWINGS

The above and other objects, features and advantages of the present invention will be more apparent from the following detailed description taken in conjunction with the accompanying drawings:

FIG. 1 illustrates an exemplary structure of a polarizing substrate according to an exemplary embodiment of the present invention;

FIG. 2 shows an exemplary process of manufacturing an exemplary polarizing substrate according to an exemplary embodiment of the present invention;

FIG. 3 illustrates an exemplary structure of an exemplary variable transmissivity device according to an embodiment of the present invention; and

FIG. 4 illustrates an exemplary structure of an exemplary variable transmissivity device according to an exemplary embodiment of the present invention.

### DETAILED DESCRIPTION

Hereinafter, some embodiments of the present invention will be described in detail with reference to the exemplary drawings. In adding the reference numerals to the components of each drawing, it should be noted that the identical or equivalent component is designated by the identical numeral even when they are displayed on other drawings. Further, in describing the embodiment of the present invention, a detailed description of well-known features or functions will be ruled out in order not to unnecessarily obscure the gist of the present invention.

In describing the components of the embodiment according to the present invention, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present invention pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

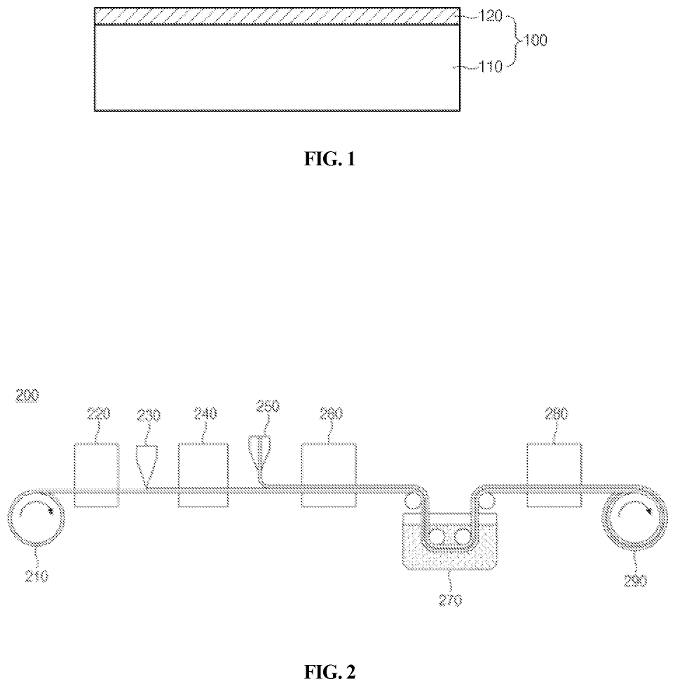

FIG. 1 illustrates a structure of a polarizing substrate according to embodiments of the present invention. A polarizing substrate 100 may include a base layer 110 and a polarizing layer 120.

The base layer 110, which serves as a base in the configuration of the polarizing substrate 100, may be implemented as a transparent medium. The base layer 110 may include a plastic film. For example, the base layer 110 may be implemented as a plastic film. As the plastic film, at least one of a cycloolefin copolymer (COP) film, a polycarbonate (PC) film, a polypropylene (PP) film, a polyethylene (PE) film, or poly (methyl methacrylate) (PMMA) film may be used. The base layer 110 may be made of the plastic film as an example, but is not limited thereto. Alternatively, the base layer 110 may be implemented using glass.

The polarizing layer 120 may be deposited (e.g., stacked) on at least one of opposite surfaces of the base layer 110. The polarizing layer 120 may be formed by coating a dye on one surface of the base layer 110. A slit width (slit resolution or slit density) formed in the polarizing layer 120 may be adjusted to vary a polarization efficiency of the polarizing layer 120. As the polarization efficiency of the polarizing layer 120 is changed, an initial transmissivity (i.e., initial transparency) of the polarizing layer 120 may be changed. For example, when the polarization efficiency of the polarizing layer 120 is reduced from about 50% to about 30%, the initial transparency may be changed from 0% to about 20%. When the polarization efficiency of the polarizing layer 120 is reduced, the initial transparency of the polarizing substrate 100 may be increased, and therefore, a user is capable of shifting a transmissivity conversion level.

FIG. 2 shows an exemplary process of manufacturing an exemplary polarizing substrate according to an exemplary embodiment of the present invention. A manufacturing apparatus 200 may include a feeding device 210, a first surface treatment device 220, a second surface treatment device 230, a first drying device 240, a coating device 250, a second drying device 260, a passivation device 270, a third drying device 280, and a winding device 290. In the embodiment, a case in which the base layer 110 is implemented as the plastic film is described as an example to aid in understanding the description.

The feeding device 210 may unwind the plastic film and convey the plastic film to the first surface treatment device 220.

The first surface treatment device 220 and the second surface treatment device 230 may surface-treat one surface of the plastic film unwound from the feeding device 210 in at least one direction. The first surface treatment device 220 may perform corona treatment and the second surface treatment device 230 may perform a primer treatment. For example, the first surface treatment device 220 may remove particles attached to the surface of the plastic film using plasma. The second surface treatment device 230 may coat a primer on the surface of the plastic film from which particles are removed. The first drying device 240 may dry the surface of the plastic film surface-treated by the first surface treatment device 220 and the second surface treatment device 230.

The coating device 250 may form the polarizing layer 120 by coating the dye on the surface of the plastic film that is passed through the first drying device 240. The coating device 250 may form a slit pattern by directly coating the dye on the surface of the plastic film. When forming the slit pattern, a slit width may be adjusted to adjust the initial transmissivity. The coating method may be not limited thereto and at least one of the known coating methods may be selectively applied thereto.

The second drying device 260 may dry the polarizing layer 120 coated in a coating process performed by the coating device 250. The passivation device 270 may coat a protective film on the polarizing layer 120 that is passed through the second drying device 260, and the third drying device 280 may dry the coated protective film. The winding device 290 may wind the plastic film on which the polarizing layer 120 is coated.

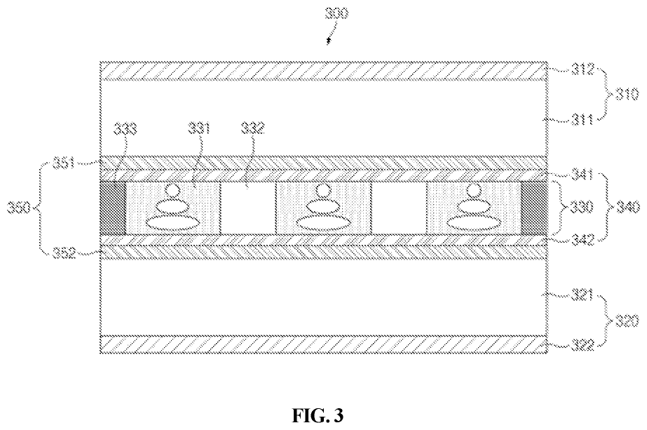

FIG. 3 illustrates an exemplary structure of an exemplary variable transmissivity device according to an embodiment of the present invention.

A variable transmissivity device 300 may adjust the amount of light passing through and may be applied to a window of a vehicle and/or a window of a building. The variable transmissivity device 300 may include a first polarizing substrate 310, a second polarizing substrate 320, a liquid crystal layer 330, an alignment layer 340, and a transparent electrode 350.

The first polarizing substrate 310 and the second polarizing substrate 320 may serve to align light spreading in all directions in one direction. The first polarizing substrate 310 and the second polarizing substrate 320 may be manufactured through the manufacturing process disclosed in FIG. 2.

As shown in FIG. 1, the first polarizing substrate 310 and the second polarizing substrate 320 may each include a base layer and a polarizing layer. Preferably, the first polarizing substrate 310 may include a first base layer 311 and a first polarizing layer 312 stacked on a first surface of the first base layer 311. The second polarizing substrate 320 may include a second base layer 321 and a second polarizing layer 322 stacked on a first surface of the second base layer 321. The first polarizing layer 312 and the second polarizing layer 322 may be formed on the first surface of the first base layer 311 and the first surface of the second base layer 321 through a coating process, respectively. The first polarizing layer 312 and the second polarizing layer 322 may pass only light in a specific direction.

The liquid crystal layer 330 may be disposed between the first polarizing substrate 310 and the second polarizing substrate 320. The liquid crystal layer 330 may include a plurality of cells 331, with which a polymer (i.e., liquid crystal) may be filled, at predetermined intervals. A space between the cells 331 may be maintained by a spacer 332. The spacer 332 may be implemented as a ball spacer or a column spacer. Also, the spacer 332 may be replaced with a monomer. The monomer has curing characteristics when exposed to UV in a specific wavelength range. The outermost edge of the liquid crystal layer 330 may be sealed with a sealant 333 to prevent the liquid crystal from leaking.

The liquid crystal layer 330 may change the alignment of the liquid crystal to adjust the amount of light (transmissivity). For example, when the liquid crystal layer 330 is implemented as a twisted nematic (TN) liquid crystal, the liquid crystal layer 330 may be aligned so that a direction of light is capable of being changed to 90 degrees during manufacturing. Accordingly, the liquid crystal layer 330 may maintain the highest transmissivity when power is not applied, and when power is applied, a phase may be switched so to that the alignment of the TN liquid crystal blocks light, thereby maintaining the transmissivity low.

The alignment layer 340 may include a first alignment layer 341 and a second alignment layer 342 disposed to face each other. Preferably, the first alignment layer 341 may be disposed on the first surface of the liquid crystal layer 330 and the second alignment layer 342 may be disposed a second surface of the liquid crystal layer 330 opposite to the first surface of the liquid crystal layer 330. As the alignment layer 340, polyimide or polyamic acid may be used.

The alignment layer 340 is a layer in which liquid crystal molecules are aligned in a specific arrangement and direction. The cell 331 with which the liquid crystal is fill is formed between the first alignment layer 341 and the second alignment layer 342, and liquid crystal molecules may be arranged in the corresponding cell 331.

The transparent electrode 350 may include a first transparent electrode 351 and a second transparent electrode 352. The first transparent electrode 351 may be disposed between the first base layer 311 and the first alignment layer 341 of the first polarizing substrate 310, and the second transparent electrode 352 may be disposed between the second base layer 321 and the second alignment layer 342 of the second polarizing substrate 320. The first transparent electrode 351 and the second transparent electrode 352 may be formed by depositing indium tin oxide (ITO). In addition, various materials and methods for forming the transparent electrode may be known and may be applied without limitation. When an electric signal is applied to the first transparent electrode 351 and the second transparent electrode 352, the liquid crystal arrangement of the liquid crystal layer 330 may be adjusted to change the transmissivity of the liquid crystal layer 330. The transmissivity of the liquid crystal layer 330 may be controlled through a phase change of the liquid crystal due to an electronic field applied to the liquid crystal layer 330.

The variable transmissivity device 300 may adjust a transmissivity variable range depending on the polarization efficiency of the polarizing substrates 310 and 320. For example, when the polarization efficiency of each of the polarizing substrates 310 and 320 is an ideal polarization efficiency of about 50%, the transmissivity variable range is 50% to 0%. In addition, as the polarization efficiency of each of the polarizing substrates 310 and 320 decreases by about 10%, about 20%, and about 30%, the transmissivity variable range may also be adjusted to about 60% to 10%, about 70% to 20%, and about 80% to 30%.

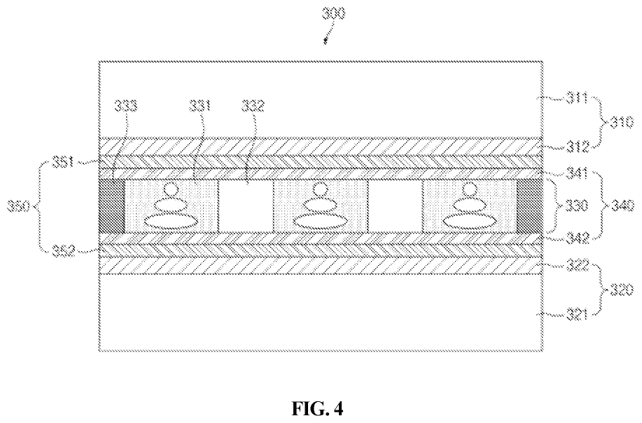

FIG. 4 illustrates an exemplary structure of an exemplary variable transmissivity device according to an exemplary embodiment of the present invention.

The variable transmissivity device 300 may include the first polarizing substrate 310, the second polarizing substrate 320, the liquid crystal layer 330, the alignment layer 340, and the transparent electrode 350.

The first polarizing substrate 310 and the second polarizing substrate 320 may pass only light in a specific direction. The first polarizing substrate 310 and the second polarizing substrate 320 may be manufactured through the manufacturing process disclosed in FIG. 2.

As shown in FIG. 1, the first polarizing substrate 310 and the second polarizing substrate 320 may each include a base layer and a polarizing layer. Preferably, the first polarizing substrate 310 may include the first base layer 311 and the first polarizing layer 312 stacked on a second surface of the first base layer 311. The second polarizing substrate 320 may include the second base layer 321 and the second polarizing layer 322 stacked on a second surface of the second base layer 321. The first polarizing layer 312 and the second polarizing layer 322 may be formed through a coating process, respectively.

The liquid crystal layer 330 may be disposed between the first polarizing substrate 310 and the second polarizing substrate 320. The liquid crystal layer 330 may include the plurality of cells, with which the polymer (i.e., liquid crystal) is filled, at the predetermined intervals. The space between the cells 331 may be maintained by the spacer 332. The spacer 332 may be implemented as a ball spacer or a column spacer. Also, the spacer 332 may include, e.g., being replaced with a monomer. The monomer has curing characteristics when exposed to UV in a specific wavelength range. The outermost portion of the liquid crystal layer 330 may be sealed with the sealant 333 to prevent liquid crystal from leaking.

The alignment layer 340 may include the first alignment layer 341 and the second alignment layer 342 disposed to face each other. Preferably, the first alignment layer 341 may be disposed on the first surface of the liquid crystal layer 330 and the second alignment layer 342 may be disposed on the second surface of the liquid crystal layer 330 opposite to the first surface of the liquid crystal layer 330. As the alignment layer 340, polyimide or polyamic acid may be used.

The transparent electrode 350 may include the first transparent electrode 351 and the second transparent electrode 352. The first transparent electrode 351 may be disposed between the first polarizing layer 312 of the first polarizing substrate 310 and the first alignment layer 341, and the second transparent electrode 352 may be disposed between the second polarizing layer 322 of the second polarizing substrate 320 and the second alignment layer 342. The first transparent electrode 351 and the second transparent electrode 352 may be formed by depositing indium tin oxide (ITO). In addition, various materials and methods for forming a transparent electrode may be known and may be applied without limitation. When an electric signal is applied to the first transparent electrode 351 and the second transparent electrode 352, the liquid crystal arrangement of the liquid crystal layer 330 may be adjusted to change the transmissivity of the liquid crystal layer 330. Preferably, the transmissivity of the liquid crystal layer 330 may be controlled through a phase change of the liquid crystal due to an electronic field applied to the liquid crystal layer 330.

According to various exemplary embodiments of the present invention, the polarizing layer may be formed by the coating method to reduce the thickness of the polarizing layer even while providing the same polarizing function as in the conventional polarizing substrate.

In addition, according to various exemplary embodiment of the present invention, the polarizing layer may be formed by the coating method to minimize change in the existing process and to improve the issue related to deterioration due to the thermal expansion coefficient of the film.

Hereinabove, although the present invention has been described with reference to exemplary embodiments and the accompanying drawings, the present invention is not limited thereto, but may be variously modified and altered by those skilled in the art to which the present invention pertains without departing from the spirit and scope of the present invention claimed in the following claims. Therefore, the exemplary embodiments of the present invention are provided to explain the spirit and scope of the present invention, but not to limit them, so that the spirit and scope of the present invention is not limited by the embodiments. The scope of the present invention should be construed on the basis of the accompanying claims, and all the technical ideas within the scope equivalent to the claims should be included in the scope of the present invention.

1. A polarizing substrate comprising:
a transparent base layer; and
a polarizing layer formed on at least one surface of the base layer,
wherein the polarizing layer is formed by a coating method.

2. (canceled)

3. The polarizing substrate of claim 1, wherein the polarizing layer has a polarization efficiency which is varied by a silt width formed in the polarizing layer,
wherein the slit width is given a predetermined value based on a desired transmittance or a desired polarization efficiency.

4. The polarizing substrate of claim 1, wherein the base layer comprises a plastic film.

5. A variable transmissivity device comprising:
a first polarizing substrate and a second polarizing substrate, each of which includes a transparent base layer and a polarizing layer formed on at least one surface of the base layer;
a liquid crystal layer disposed between the first polarizing substrate and the second polarizing substrate;
a first alignment layer and a first transparent electrode stacked on a first surface of the liquid crystal layer in a direction in which the first polarizing substrate is positioned; and
a second alignment layer and a second transparent electrode stacked on a second surface of the liquid crystal layer opposite to the first surface of the liquid crystal layer in a direction in which the second polarizing substrate is positioned,
wherein each of the polarizing layers has a polarization efficiency which is varied by a slit width formed in the polarizing layer, and
wherein the slit width is given a predetermined value based on a desired transmittance or a desired polarization efficiency.

6. The variable transmissivity device of claim 5, wherein each of the polarizing layers is formed by coating a plastic resin.

7. (canceled)

8. The variable transmissivity device of claim 5, wherein each of the base layers comprises a plastic film.

9. The variable transmissivity device of claim 5, wherein the first transparent electrode is disposed between a first base layer of the first polarizing substrate and the first alignment layer, and
wherein the second transparent electrode is disposed between a second base layer of the second polarizing substrate and the second alignment layer.

10. The variable transmissivity device of claim 5, wherein the first transparent electrode is disposed between a first polarizing layer of the first polarizing substrate and the first alignment layer, and
wherein the second transparent electrode is disposed between a second polarizing layer of the second polarizing substrate and the second alignment layer of the second polarizing substrate.

11. The variable transmissivity device of claim 5, wherein the liquid crystal layer includes:
a plurality of cells with which a liquid crystal is filled; and
a spacer to maintain a gap between the plurality of cells.

12. The variable transmissivity device of claim 11, wherein the liquid crystal comprises a polymer.

13. The variable transmissivity device of claim 11, wherein the spacer comprises a ball spacer or a column spacer.

14. The variable transmissivity device of claim 11, wherein the spacer comprises a monomer.

15. A polarizing substrate comprising:
a transparent base layer; and
a polarizing layer formed on at least one surface of the base layer,
wherein the polarizing layer has a polarization efficiency which is varied by a slit width formed in the polarizing layer,
wherein the slit width is given a predetermined value based on a desired transmittance or a desired polarization efficiency.

16. The polarizing substrate of claim 15, wherein the base layer comprises a plastic film.
